(19) United States
(12) Patent Application Publication
(10) Pub. No.: US 2006/0009994 A1
(43) Pub. Date: Jan. 12, 2006

(54) System and method for reputation rating

(76) Inventors: Tad Hogg, Mountain View, CA (US); Lada Adamic, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/887,120

(22) Filed: Jul. 7, 2004

(51) Int. Cl. G06Q 99/00

(52) U.S. Cl. 705/1

(57) ABSTRACT

A system and method for reputation rating is disclosed. The method discloses: collecting a set of reputation ratings on a target entity from a set of reputation rating entities; attributing a weight to each of the reputation ratings based on a set of filtering criteria; and combining the weighted reputation ratings to generate a filtered reputation rating with respect to the target entity. The system discloses various means, mediums and systems for effecting the method.

### BACKGROUND OF THE INVENTION

1. Field of the Invention

The present invention relates generally to reputation rating systems and methods, and more particularly to filtering reputation ratings with online networks.

2. Discussion of Background Art

In the context of e-commerce, reputations often involve a rating system in which parties to a transaction rate each other based on whether they fulfilled the terms of the exchange as promised (e.g., as provided by eBay). Reputation mechanisms help establish trust in economic transactions where some aspects of a transaction are not readily observable by some of the participants, at least prior to completing the transaction. For example, whether the quality of a good or service offered for sale is as good as the vendor claims. People considering new transactions then use the ratings as part of their decision of whom to do business with.

One difficulty with applying a ratings-based reputation system is the possibility of manipulating ratings either through collusion within groups of friends or the creation of false identities. Such groups can give mutually high ratings in spite of poor actual performance, distorting the reported reputation values. To help address this problem, several groups have proposed using information available in social networks.

One approach has been to construct a social network from past ratings given by one user to another based on just the most recent interaction. Users can rate anyone they know, whether they are a social contact or someone they have conducted a business transaction with. Ratings are then filtered through the social network to produce personalized results for each user.

There are two disadvantages to this approach. The first is that it does not distinguish between actual social contacts and business transactions. Hence one cannot filter ratings based only on actual social contacts. It also makes it susceptible to collusion, since friends can rate each other highly and these ratings are treated the same as ratings based on business transactions.

The second disadvantage is that it only considers a single rating from any one person no matter how much experience, i.e., number of transactions, they may have with the individual one wishes to obtain a rating for. While this approach may limit how much friends can inflate each other's ratings by repeatedly giving high praise to one another, it discards a great deal of potentially useful information, namely the amount of experience a person has with a particular vendor.

A second approach to using social networks is as an implicit rating system. In this case, an entity's position in a social network gives some indication of that entity's reputation, without requiring an explicit effort on the part of other network members to provide reputation ratings on that entity. This approach is useful to the extent that social connectivity correlates with the entity's likely behavior with respect to business transactions. Automated management of reputation ratings, both for service quality and ratings reliability, can also aid in producing a reliable reputation rating mechanism. Unfortunately, the available social network may have only marginal relation to how well the entity its customers, in which case explicit ratings are potentially much more relevant for reputations.

In response to the concerns discussed above, what is needed is a system and method for reputation rating that overcomes the problems of the prior art.

### SUMMARY OF THE INVENTION

The present invention is a system and method for reputation rating. The method of the present invention includes the elements of: collecting a set of reputation ratings on a target entity from a set of reputation rating entities; attributing a weight to each of the reputation ratings based on a set of filtering criteria; and combining the weighted reputation ratings to generate a filtered reputation rating with respect to the target entity. The system of the present invention includes all means, mediums and systems for effecting the method.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of one embodiment of a system for reputation rating;

FIG. 2 is a flowchart of one embodiment of a root method for reputation rating; and

FIG. 3 is a flowchart of one expanded embodiment of the root method for reputation rating.

### DETAILED DESCRIPTION OF THE PREFERRED EMBODIMENT

The present invention uses available online networks to make it more difficult to subvert reputation mechanisms (e.g. spoofing or collusion) used to rate entity's with respect to their e-commerce transactions while maintaining flexibility to include differing user views on the significance of various raters, using various filtering methods.

With reduced opportunities for spoofing or collusion, participants are likely to regard reputation ratings as more accurately reflecting an entity's actual e-commerce behaviors. The availability of more accurate reputation information has also been shown to promote better behavior and higher economic efficiency in other settings.

While online networks are fairly new, they are growing rapidly, and the fact that these networks are available online allows automated use of their structure for a variety of tasks, beyond just the filtering of reputation ratings discussed herein.

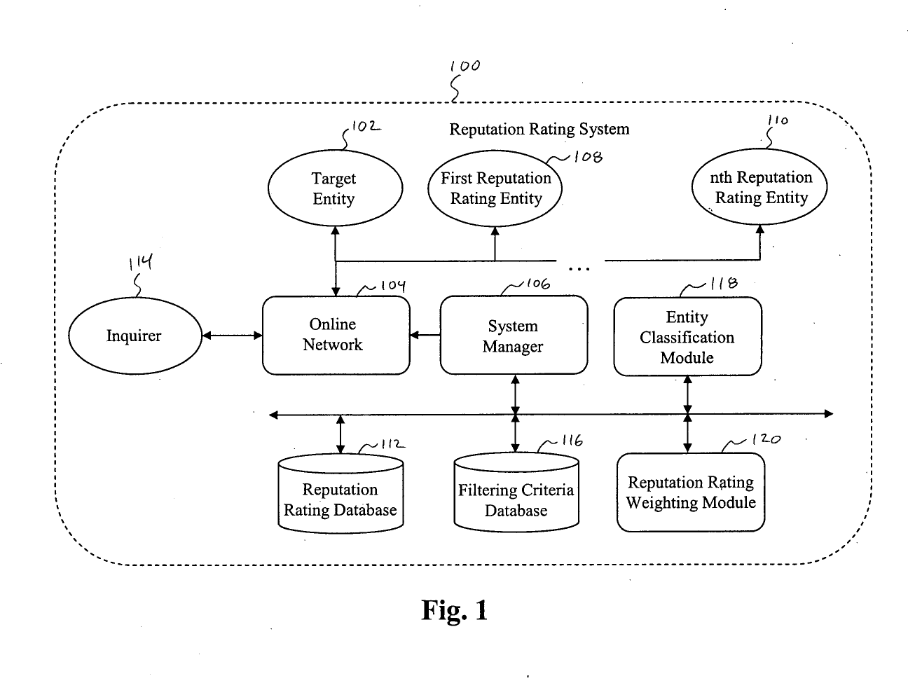

FIG. 1 is a dataflow diagram of one embodiment of a system 100 for reputation rating. To begin, a target entity 102 (i.e., the person or business to have their reputation rated) establishes an online presence within an online network 104.

The online network 104 is herein defined as one containing information on relationships among entities (e.g. people, businesses, etc.) either directly or via their behavior. Online networks typically consist of links among entities indicating various forms of relationship, social or otherwise. Online networks containing such relationship information are preferred as compared to more general online networks, such as those including just “people connected to the internet” and responding to email, instant messages, and so on.

A range of services, including Friendster, LinkedIn, and Spoke (see www.friendster.com, www.linkedin.com, and www.spoke.com), build online networks. These networks have rapidly acquired millions of entities and assist them in forming new social or business contacts or relationships through the contacts they already have. Entities either manually enumerate their contacts or these are gathered automatically from an entity's e-mail correspondence. Additional sources from which social connections can be automatically harvested include links on web home pages, common authorship of papers, and webs of trust for decentralized cryptographic keys.

While the online network 104 is preferably an online social network, those skilled in the art will recognize that other types of network information may be used as well, such as credit card transaction information, and phone call records.

A system manager 106 collects a set of reputation ratings on the target entity 102 from a set of reputation rating entities 108 through 110 who have provided such rating data over the network 104. The system manager 106 stores the reputation ratings in a reputation ratings database 112.

An inquirer 114 contacts the system manager 106 and requests the target entity's 102 reputation rating. The inquirer 114 is an entity who is attempting to gain information about the target entity's reputation. The inquirer 114 is typically a person or business interested in establishing a business relationship with or purchasing a good or service from the target entity 102.

The system manager 106 requests a set of filtering criteria from the inquirer 114. The set of filtering criteria is used to classify (i.e. assign) the reputation rating entities 108 through 110 and weight their respective reputation ratings. The system manager 106 stores the set of filtering criteria in a filtering criteria database 116.

An entity classification module 118 assigns the reputation rating entities 108 through 110 into either a default set of classes or a set of classes which have been defined by the filtering criteria provided by the inquirer 114. Note, that some reputation rating entities 108 through 110 may be assigned to more than one class.

In one example, the reputation rating entities 108 through 110 are classified based on how “close” the reputation rating entities are to the target entity 102. Closeness is defined either by a default set of criteria, or based on the inquirer's 114 filtering criteria. For example, if “closeness” is predefined as the target entity's 102 immediate social circle (e.g. perhaps including family members, friends, classmates, etc.), then the entity classification module 118 examines the relationships between the reputation rating entities 108 through 110 and the target entity 102 within the online network 104 and identifies which of the reputation rating entities fall within the target entity's 102 immediate social circle.

In another example, the reputation rating entities 108 through 110 are classified based on how “close” the reputation rating entities 108 through 110 are to the inquirer 114 according to either the same or a different “closeness” definition. In this way the inquirer's 114 friends can be singled out and, later in this method, have their reputation ratings given greater weight (e.g. emphasize your friends).

In another example, the reputation rating entities 108 through 110 are classified based on how “close” the reputation rating entities 108 through 110 are to one or more of the reputation rating entities 108 through 110 according to some predetermined “closeness” definition. In this way the inquirer 114 can separate out particular reputation rating entities to whom, later in this method, the inquirer 114 can either emphasize or deemphasize such reputation rating entities' reputation ratings (e.g. deemphasize their friends).

In yet another example, the reputation rating entities 108 through 110 are classified based on whether the reputation rating entities 108 through 110 are members of a predefined sub-set of the online network 104. One sub-set, could be whether a reputation rating entity is a member of a particular social network so that reputation rating entities having a false identity can be selected out (e.g. a reputation rating entity without connections, or a reputation rating entity having exactly a same set of connections within the online network as another a reputation rating entity). Thus, target entities, hoping for a fair reputation rating, would be encouraged to fully disclose all of their social network connections over the online network 104 so as not to have certain reputation rating entities improperly tagged as having a false identity.

Another sub-set could be defined to include only the target entity's 102 near neighbors in the online network (e.g. professional contacts), based on the inquirer's 114 belief that the reputation ratings provided by such professional contacts would be based on better information which would tend to outweigh the potential for collusion by such professional contacts with respect to the target entity. An example of this is asking for physicians' opinions about other physicians they have worked with.

Yet another sub-set can be defined based on the experience a reputation rating entity may have with the target contact 102 (i.e. entities who have posted ratings on the target entity 102). An example of this would be reputation rating entities who have actually purchased goods from the target entity 102 and have made their prior business relationships available as part of the online network 104.

Once the reputation rating entities 108 through 110 have been assigned into one or more classes, a reputation rating weighting module 120 attributes a weight to each of the reputation ratings based on a default weighting schema, or on the filtering criteria provided by the inquirer.

For example, a reputation rating from a particular reputation rating entity is weighted based on how “close” the particular reputation rating entity is to the target entity 102. Thus, the inquirer 114 can either exclude (i.e. zero weight) or less heavily weight reputation ratings from the target entity's 102 immediate social circle under an assumption that said circle would provide reputation ratings biased in the target entity's favor.

In another example, a reputation rating from a particular reputation rating entity is weighted based on how “close” the particular reputation rating entity is to the inquirer 114. Thus, the inquirer 114 can more heavily weight reputation ratings from the inquirer's 114 own immediate social circle under an assumption that said circle would provide reputation ratings more in line with the inquirer's 114 own biases (e.g. emphasizing “word of mouth” ratings).

In another example, a reputation rating from a particular reputation rating entity is weighted based on how “close” the particular reputation rating entity is to one or more of the reputation rating entities 108 through 110. Thus, the inquirer 114 can more heavily weight reputation ratings from groups including one or more known experts in a particular field, or exclude reputation ratings from groups known to host derogatory web sites with respect to the target entity's 102 business dealings.

In yet another example, a reputation rating from a particular reputation rating entity is weighted based which sub-sets of the online network 104 the particular reputation rating entity is a member of. Thus, the inquirer 114 can more heavily weight reputation ratings from entities who are members of a professional organization and who have previously had business dealings with the target entity 102.

Next, the system manager 106 combines the weighted reputation ratings to generate a filtered reputation rating for the target entity 102. Those skilled in the art recognize that the weighted reputation ratings may be combined according to a variety of different mathematical formulas. Such formulas include an average reputation rating, a median reputation rating, as well as others. Thus, one of the present invention's benefits is for users to select various combining criteria. For example, if a target entity's reputation is decreasing over time, even though still with a high average value due to many well-rated transactions in the past, some users may pick a combining function that emphasizes recent history rather than just an average over all the ratings.

The present invention's use of a variety of reputation rating filtering criteria, based on the inquirer's 114 preferences, a set of defaults, and additional available information (e.g., content of web home pages), gives flexibility in interpreting the reputation ratings available over the online network 104. Those skilled in the art will know of other ways in which the reputation rating entities can be assigned and their respective reputation ratings weighted.

Using the relationships within the online network 104 to filter the reputation ratings makes spoofing the reputation system more difficult. For instance, altering reputation scores requires collusion not only among friends, but also those further removed in the network, e.g., of friends of friends, etc. which is more difficult. Moreover, if users use a variety of filtering strategies, a vendor attempting to spoof one kind of filter could in fact be detrimental with respect to another.

The present invention invention's use of assigning and filtering should be highly effective since reputation rating entities who may deliberately alter revealed links within the online network 104, in an attempt to hide collusion with respect to their reputation ratings, risk losing the other benefits for which such networks are constructed, such as to obtain business referrals. Moreover, large-scale analysis of social networks can uncover at least some forms of collusion. For example, web pages colluding to alter their search engine ranking can be identified and removed if they all have a similar number of links. Alternately, collusion could alter the relative abundance of motifs (small subgraphs), arousing suspicion if it differs significantly from that of social networks in general. Also, the high clustering in social networks (i.e., two friends of a person are much more likely to be friends themselves than would be the case in a random graph) means that collusion among friends to hide their mutual link would usually not greatly increase the distance between them in the social network. Hence a filter based on social network distance (i.e. “closeness”) would be relatively insensitive to such deliberately altered links.

As a specific example implementation of the present invention, an inquirer wants to enter into a business transaction with one of a set of target entities. The target entities are members of an online network and are respectively associated with a set of reputation ratings {r₁, . . . ,rₙ} generated by “n” reputation rating entities within the online network. An average, unfiltered, reputation rating for each target entity is equal to (r₁+ . . . rₙ)/n.

However, using the filtering criteria supplied by the inquirer, a weighted average reputation rating r=(w₁r₁+ . . . +wₙrₙ)/(w₁+ . . . +wₙ) can be generated for each of the target entities. If the inquirer specifies only a “closeness” filtering in the filtering criteria, each of the weights are determined by a distance dᵢ between each of the target entities and an i^{th} reputation rating entity. Exactly how the weights are assigned based on the distance depends on additional parameters within the filtering criteria provided by the inquirer. For example, to filter out (i.e. assign zero weight to) reputation ratings from all reputation rating entities within distance “two” of the target (i.e., the target's friends and friends of friends), set wᵢ=1 if dᵢ>2 and set wᵢ=0 otherwise. The inquirer receives these weighted ratings for all of the target entities and then decides with whom to do business.

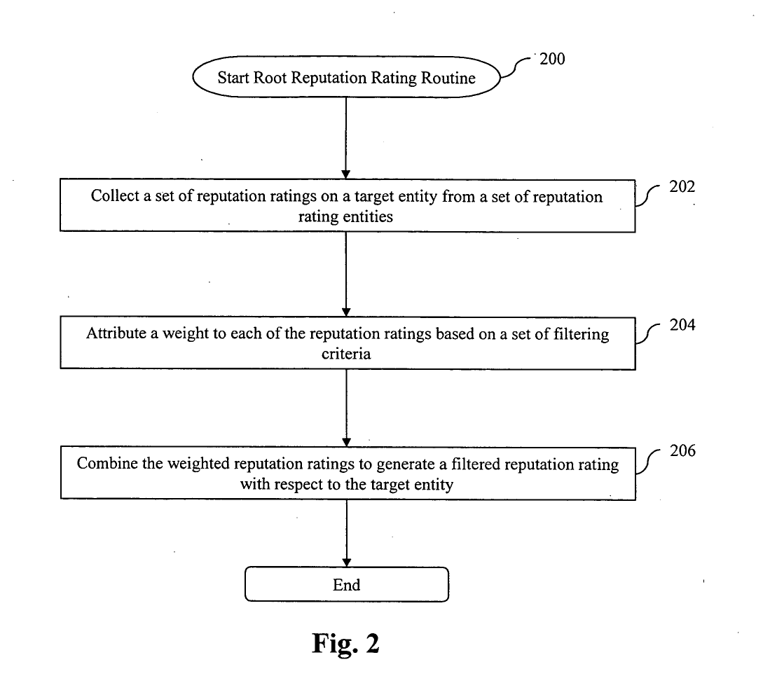

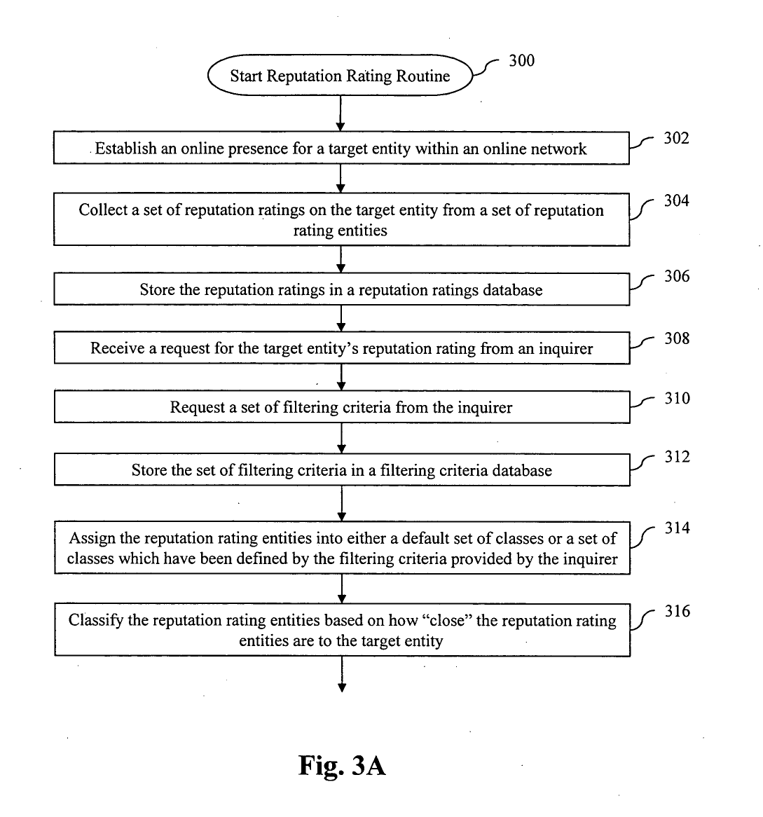

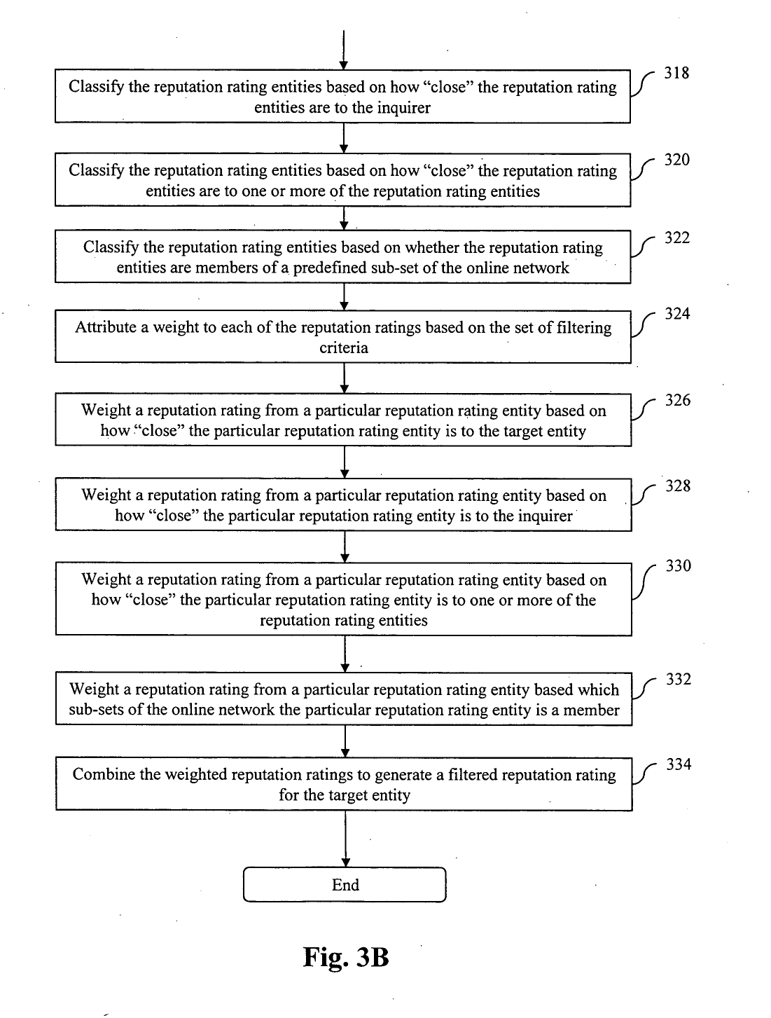

FIG. 2 is a flowchart of one embodiment of a root method 200 for reputation rating. The method 200 begins in step 202, where a set of reputation ratings on a target entity are collected from a set of reputation rating entities. Next, in step 204, a weight is attributed to each of the reputation ratings based on a set of filtering criteria. Then in step 206, the weighted reputation ratings are combined to generate a filtered reputation rating with respect to the target entity. The root method 200 is discussed in further detail with respect to FIG. 3.

FIG. 3 is a flowchart of one expanded embodiment 300 of the root method for reputation rating. To begin, in step 302, a target entity 102 establishes an online presence within an online network 104. In step 304, a system manager 106 collects a set of reputation ratings on the target entity 102 from a set of reputation rating entities 108 through 110 who have provided such rating data over the network 104. In step 306, the system manager 106 stores the reputation ratings in a reputation ratings database 112. In step 308, an inquirer 114 contacts the system manager 106 and requests the target entity's 102 reputation rating. In step 310, the system manager 106 requests a set of filtering criteria from the inquirer 114. In step 312, the system manager 106 stores the set of filtering criteria in a filtering criteria database 116.

In step 314, an entity classification module 118 assigns the reputation rating entities 108 through 110 into either a default set of classes or a set of classes which have been defined by the filtering criteria provided by the inquirer 114. For example, in step 316, the reputation rating entities 108 through 110 are classified based on how “close” the reputation rating entities are to the target entity 102. In step 318, the reputation rating entities 108 through 110 are classified based on how “close” the reputation rating entities 108 through 110 are to the inquirer 114 according to either the same or a different “closeness” definition. In step 320, the reputation rating entities 108 through 110 are classified based on how “close” the reputation rating entities 108 through 110 are to one or more of the reputation rating entities 108 through 110 according to some predetermined “closeness” definition. In step 322, the reputation rating entities 108 through 110 are classified based on whether the reputation rating entities 108 through 110 are members of a predefined sub-set of the online network 104.

In step 324, a reputation rating weighting module 120 attributes a weight to each of the reputation ratings based on a default weighting schema, or on the filtering criteria provided by the inquirer. For example, in step 326, a reputation rating from a particular reputation rating entity is weighted based on how “close” the particular reputation rating entity is to the target entity 102. In step 328, a reputation rating from a particular reputation rating entity is weighted based on how “close” the particular reputation rating entity is to the inquirer 114. In step 330, a reputation rating from a particular reputation rating entity is weighted based on how “close” the particular reputation rating entity is to one or more of the reputation rating entities 108 through 110. In step 332, a reputation rating from a particular reputation rating entity is weighted based which sub-sets of the online network 104 the particular reputation rating entity is a member of. Next, in step 334, the system manager 106 combines the weighted reputation ratings to generate a filtered reputation rating for the target entity 102.

While one or more embodiments of the present invention have been described, those skilled in the art will recognize that various modifications may be made. Variations upon and modifications to these embodiments are provided by the present invention, which is limited only by the following claims.

What is claimed is:

1. A method for reputation rating, comprising:
collecting a set of reputation ratings on a target entity from an online social network that includes the target entity and a set of reputation rating entities;
attributing a weight to each of the reputation ratings based on a set of filtering criteria; and
combining the weighted reputation ratings to generate a filtered reputation rating with respect to the target entity.

2. The method of claim 1 further comprising:
receiving a request for the target entity's reputation rating from an inquirer; and
requesting the set of filtering criteria from the inquirer.

3. The method of claim 2:
wherein collecting includes collecting the reputation ratings on a business; and
wherein receiving includes receiving a request for the business' reputation rating from a purchaser.

4. The method of claim 1, wherein attributing includes:
assigning the reputation rating entities into one or more classes, using the set of filtering criteria; and
attributing a weight to each of the reputation ratings based on which classes each respective reputation rating entity is a member of.

5. The method of claim 4:
wherein assigning includes assigning a reputation rating entity to more than one class.

6. The method of claim 4:
wherein assigning includes classifying a particular reputation rating entity based on how “close” the particular reputation rating entity is to the target entity.

7. The method of claim 6:
wherein close is defined as being within the target entity's immediate social circle.

8. The method of claim 6:
wherein close is defined as being a family member of the target entity.

9. The method of claim 6:
wherein close is defined as being a friend of the target entity.

10. The method of claim 4:
wherein assigning includes classifying a particular reputation rating entity based on how “close” the particular reputation rating entity is to the inquirer.

11. The method of claim 4:
wherein assigning includes classifying a particular reputation rating entity based on how “close” the particular reputation rating entity is to one or more of the reputation rating entities.

12. The method of claim 4:
wherein assigning includes classifying a particular reputation rating entity based on whether the particular reputation rating entity is a member of one or more predefined sub-sets of the online network.

13. The method of claim 12:
wherein a sub-set is defined as those entities appearing without a connection in the online network.

14. The method of claim 12:
wherein a sub-set is defined as those entities having exactly a same set of connections within the online network as another entity.

15. The method of claim 12:
wherein a sub-set is defined as those entities which are near neighbors of the target entity in the online network.

16. The method of claim 12:
wherein a sub-set is defined as those entities who have posted a reputation rating on the target entity.

17. The method of claim 1:
wherein combining includes averaging the weighted reputation ratings to generate an average reputation rating for the target entity.

18. A method for reputation rating, comprising:
collecting a set of reputation ratings on a business from a set of reputation rating entities available on an online social network;
receiving a request for the business' reputation rating from an inquirer;
requesting a set of filtering criteria from the inquirer;
assigning the reputation rating entities into one or more classes, using the set of filtering criteria;
attributing a weight to each of the reputation ratings based on the set of filtering criteria and which classes each respective reputation rating entity is a member of; and
combining the weighted reputation ratings to generate a filtered reputation rating with respect to the business.

19. A computer-usable medium embodying computer program code for commanding a computer to effect reputation rating, comprising:
collecting a set of reputation ratings on a target entity from a set of reputation rating entities;
attributing a weight to each of the reputation ratings based on a set of filtering criteria; and
combining the weighted reputation ratings to generate a filtered reputation rating with respect to the target entity.

20. The medium of claim 19 further including:
assigning the reputation rating entities into one or more classes, using the set of filtering criteria; and
attributing a weight to each of the reputation ratings based on which classes each respective reputation rating entity is a member of.

21. A system for reputation rating, comprising a:
means for collecting a set of reputation ratings on a target entity from a set of reputation rating entities;
means for attributing a weight to each of the reputation ratings based on a set of filtering criteria; and
means for combining the weighted reputation ratings to generate a filtered reputation rating with respect to the target entity.
